(19) United States
(12) Patent Application Publication
(10) Pub. No.: US 2011/0293803 A1
(43) Pub. Date: Dec. 1, 2011

(54) METHOD FOR PRODUCING BLACK GARLIC CONCENTRATE

(75) Inventors: Yong Duck Ko, Changwon-si (KR); Yoo Han Ko, Changwon-si (KR); Yoo Sung Ko, Changwon-si (KR)

(73) Assignee: Saenamhae Nonghyup, Gyeongsangnam-do (KR)

(21) Appl. No.: 12/847,762

(22) Filed: Jul. 30, 2010

(30) Foreign Application Priority Data
Jun. 1, 2010 (KR) 10-2010-0051509

(51) Int. Cl. A23L 1/221; B65B 55/14

(52) U.S. Cl. 426/400

(57) ABSTRACT

There is provided a method for producing an aged black garlic concentrate comprising;
classifying the garlic by condition and pretreating for cleaning an appearance;
sealing the garlic in a polyethylene bag by 8˜10 Kg and storing in a tray;
putting said tray into an aging device for a black garlic, and steam-treating by applying steam and heat for 30˜60 min while maintaining inside the aging device at a temperature of 80˜90° C.;
main aging by aging the tray with said steam-treated garlic for 12˜15 days while maintaining inside the aging device at a temperature of 70˜80° C.;
after-aging by gradually removing the water from the tray with said main-aged garlic at a low temperature condition for 7˜14 days, while maintaining inside the aging device at a temperature of 0˜5° C.;
storing by putting raw water, and storing via the 25 μm bag filter;
primarily filtering by purifying the raw water via 5 μm filter;
secondarily filtering by purifying again said primarily filtered-purified water via 1 μm filter;
reverse osmosis filtering by removing foreign substances and ion components from said secondary filtered-purified water through the reverse osmosis step to prepare the purified water;
extracting the concentrate while maintaining at a temperature of 85˜95° C. for 18˜24 hrs by putting 1350 kg of said reverse osmosis filtered-purified water and 450 kg of said after-aged black garlic into the extractor.

### CROSS-REFERENCE TO RELATED APPLICATION

The present application claims the benefit under 35 U.S.C. §119 of Korean Patent Application No. 10-2010-0051509, filed Jun. 1, 2010, which is hereby incorporated by reference in its entirety.

### BACKGROUND OF THE INVENTION

1. Field of the Invention

The present invention relates to a method for producing a black garlic concentrate. More specifically, the present invention relates to a method for producing a black garlic concentrate comprising extracting the effective components of the black garlic by injecting purified water into the black garlic produced by aging a garlic as a raw material, and then concentrating the black garlic concentrate through a low temperature vacuum concentration process, which is a process for separating the water content up to the effective solid content defined as a quality standard from the concentrated solution extracted by using a vacuum evaporator.

2. Description of the Related Art

The garlic (Allium sativum L.) is a perennial bulb plant, which belongs to Liliaceae and Allium, and is one of the first cultivated plants in human history. It has been cultivated for at least five thousand years, and served as food ingredients as well as medicinal ingredients since the old times. Many components and effects of the garlic have been proven in different fields such as in the food industry, medical, etc., and these days many different food which include the aged garlic have been developed.

The garlic is composed of about 60% water, 28% carbohydrate (mainly fructan), 2.3% organic sulfur compound, 2% protein (mainly allinase), 1.5% cellulose, and the like. It is known that the distinctive taste and flavor of the garlic are due to allicin, one of the organic sulfur compounds of the garlic. Since the allicin is a compound with a very low solubility in water, the allicin exists as alliin type within the garlic. However, if the garlic receives a wound, or is pulverized, the alliin is changed to the allicin, which has a strong hot taste and flavor by allinase enzyme. In addition, it is known that the allicin is very unstable at room temperature, so that the allicin component is reduced by half within 2 to 16 hours, and also the allicin component is changed to other organic sulfur compounds by the reaction of other enzymes, so that distinctive multiple flavors can be produced.

Therefore, it is difficult to ingest the garlic as it is because of its strong pungent, and it is a recent trend to commercialize the garlic by various treatments because of blue casse and browning as time passes.

For example, it is known that if the allicin, which is a unique flavor of the garlic, is heated, the enzyme activity is decreased, resulting to the weakening of the unique taste and flavor of the garlic, increase in the contents of polyphenol and flavonoid, which are antioxidants, and significant increase of the sugar content.

In particular, the garlic aging process that maintains some water as well as adds heat is popular as the more effective process to decrease the unique smell or pungent taste of the garlic and show the unique effectiveness of the components of the garlic.

As a result, the heat-treated products of the garlic, in the form of the garlic powder, the roasted garlic, the odorless garlic, etc. are used.

However, if the garlic is heat treated, it is difficult to maintain the unique components of the garlic and to flavor in the case of using the garlic as a spice.

In order to solve said problems, various methods have been proposed. Among them, Patent No. 10-0530386 of Costpluskorea Inc. discloses the method for producing the aged garlic wherein the antioxidant and polyphenol content are increased without damaging the original components and effects of garlic by self-fermenting at constant temperature and humidity.

The method for producing the aged garlic in said patent comprises aging the raw garlic for 280˜320 hrs at 40˜90° C. by hot-air, naturally drying them for 38˜42 hrs, and aging for 30˜50 hrs by hot-air with a temperature of 20˜30° C.

Also, the method for producing said patent comprises aging a raw garlic for 280˜320 hrs at 40˜90° C. by hot-air wherein after a large number of a raw garlic are put in a steel container, a large number of steel containers are aged at the container, a charcoal is placed under said steel container, or said each steel container is supplied with water.

However, said producing method have to comprise the first aging step using the electric hot gun, the natural drying step, and the drying steps between the first aging step and the second aging step, with the first aging step, so said method has a disadvantage that the garlic is not aged continuously.

In addition, said producing method has a problem in that the garlic is not aged substantially because of the long aging time. Also, the water within the garlic is evaporated too much due to the long aging time, thereby it becomes necessary to supply additional water outside to prevent hardening the garlic when it is drying.

Korean Registration Patent No. 663168 discloses the method for producing the fermentation-germinated black garlic which comprises germinating a raw garlic, heating them, dipping them into a dipping solution such as fermented brown rice solution, Sparassiscrispa extract, Phellius Linteus extract, etc., heat treating them at constant temperature and humidity for a certain period of time, and then drying them. However, there is a problem of longer fermentation-aging process period to germinate raw garlic and being rotten or spoiled during germination as well as the leakage of nutrients to the shoot by budding out.

### DETAILED DESCRIPTION OF INVENTION

### Technical Objects

The present invention is to solve said problems of the prior art, to extract aged black garlic concentrate from the aged black garlic and the purified water, to provide hot water extraction process with the optimal timing and condition for extracting concentrate from said original material.

Furthermore, the purpose of the present invention is to provide an effective producing method by saving the waste of consumption such as the material and the used energy by minimizing the amount of the used purified water and the original material in the case of extracting the aged black garlic concentrate.

### Technical Solution

The method for producing the aged black garlic concentrate by the example in order to achieve said purpose, characterized in that comprises classifying the garlic by condition and pretreating for cleaning an appearance; sealing the garlic in a polyethylene bag by 8˜10 Kg and storing in a tray; putting said tray into an aging device for a black garlic, and steam-treating by applying steam and heat for 30˜60 min while maintaining inside the aging device at a temperature of 80˜90° C.; main aging by aging the tray with said steam-treated garlic for 12˜15 days while maintaining inside the aging device at a temperature of 70˜80° C.; after-aging by gradually removing the water from the tray with said main-aged garlic at a low temperature condition for 7˜14 days, while maintaining inside the aging device at a temperature of 0˜5° C.; storing by putting raw water, and storing via the 25 μm bag filter; primarily filtering by purifying the raw water via 5 μm filter; secondarily filtering by purifying again said primarily filtered-purified water via 1 μm filter; reverse osmosis filtering by removing foreign substances and ion components from said secondary filtered-purified water through the reverse osmosis step to prepare the purified water; extracting the concentrate while maintaining at a temperature of 85˜95° C. for 18˜24 hrs by putting 1350 kg of said reverse osmosis filtered-purified water and 450 kg of said after-aged black garlic into the extractor; concentrating said garlic by maintaining the dry solid and water of said extracted black garlic in a thickener for 4˜12 hrs at 60˜76 cmHg of vacuum reduced-pressure and a temperature of 55˜85° C.; primarily filtering by separating the dry solid and water from said concentrated aged black garlic concentrate through 25˜50 μm filter; short-time pasteurizing by pasteurizing them at an ultrahigh temperature of 130˜135° C. for 1˜5 second(s) after said primary filtering; secondarily filtering by separating the dry solid and water through 5 μm filter after said short-time pasteurizing; filling them by individually wrapping said secondary filtered products with 80 ml or more at a temperature of 92˜96° C.; and testing the filled products, packaging in a box, storing at a low temperature of 1˜4° C. before their shipment.

Furthermore, said extracted aged black garlic concentrate is characterized in that has 13 brix/20° C. or more of the sugar content, and 13 weight % or more of the dry solid.

Furthermore, said concentrated aged black garlic concentrate is characterized in that has 65 brix/20° C. or more of the sugar content.

Furthermore, at said extracting step, it is characterized in that said aged black garlic and purified water are mixed, and extracted while uniformly maintaining the inner temperature deviation by circulating up and down by the operation of the circulating pump for supplying a raw material, with stirring at a speed of 30˜45 rpm.

### Effectiveness of Invention

By a method for producing aged black garlic concentrate according to the example of the present invention comprising said constitution, the extracting and concentrating process could be optimized in the course of concentrating by extracting the concentrate from the source of the aged black garlic.

### BRIEF DESCRIPTION OF THE DRAWINGS

FIG. 1 is a perspective drawing of the appearance of a black garlic aging device.

FIG. 2 is an inner perspective drawing of the inner structure of a black garlic aging device.

FIG. 3 is a drawing of the constitution of the extracting device of the aged black garlic concentrate according to the example of the present invention.

FIG. 4 is a perspective drawing of the extractor and concentrator of the extracting device of the aged black garlic concentrate according to the example of the present invention.

FIG. 5 is a flow chart of the producing process of the method for producing the aged black garlic concentrate according to the example of the present invention.

### BRIEF DESCRIPTION OF THE DRAWING MARKS

10 an aged black garlic concentrate extracting device
100 an extractor
200 a raw material providing circulating pump
300 a concentrator
400 a cooling tower
500 a primary filter
600 a mixing tank
700 a short-time high-temperature pasteurizer
800 a secondary filter
900 a filler
1000 a control part

### EMBODIMENTS OF THE INVENTION

Exemplary embodiments of the present invention will now be described in detail with reference to the accompanying drawings. However, the present will not be limited by the above-mentioned embodiments, another embodiments which is involved in the spirit and scope of the present invention or other retrogressive invention will be provided by adding, modification, deletion, etc. of another constituents.

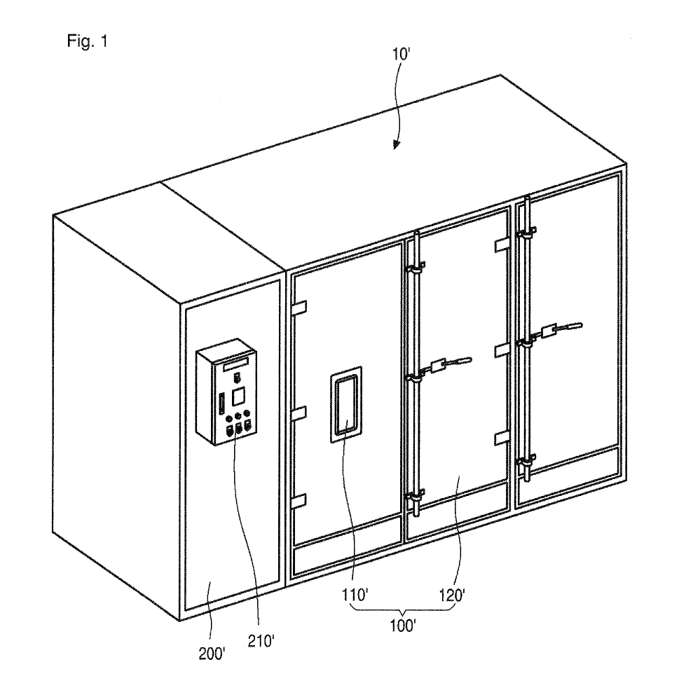

FIG. 1 is a perspective drawing of the appearance of black garlic aging device.

In FIG. 1, the aged black garlic aging device 10 according to the example of the present invention, is equipped with an aging chamber 100 where a plurality of trays (not shown) for storing the garlic for aging is stored therein, and a control chamber 200 which is equipped in the one side of said aging chamber 100 and provides the heat, steam and chilly air into said aging chamber 100, thereby the appearance is formed.

The appearance of said aging chamber 100 is divided from side to side by the door 120, the one side of said door 120 is equipped with a checking window 110 where the inner condition of said aging chamber 100 can be checked.

Further, the door 120 where it selectively shields said aging chamber 100, is installed by a hinge joint in order to assemble into said aging device 10, said door 120 seals said aging chamber 100 by a door contract opening from outer circumstance.

Further, a control part 210 where the inner condition such as the temperature, humidity, etc. of the inner part of said aging chamber 100 is displayed, and a large-capacity steam generator 220 and a compressor 230 can be operated and controlled therein, is equipped in front of said control chamber 200.

On the other hand, a ventilating shutter 140 for releasing the heat and moisture by maintaining humidity and temperature generated in said aging chamber 100 and sulphur gas out, is equipped in upper side of said aging chamber 100.

The upper corner part of said aging device 10 is equipped with the connect opening for joining with crane, etc. during movement and installation.

Said aged black garlic aging device 10 has the structures which the inner circumstance of said aging chamber 100 is unaffected by the outer circumstance condition.

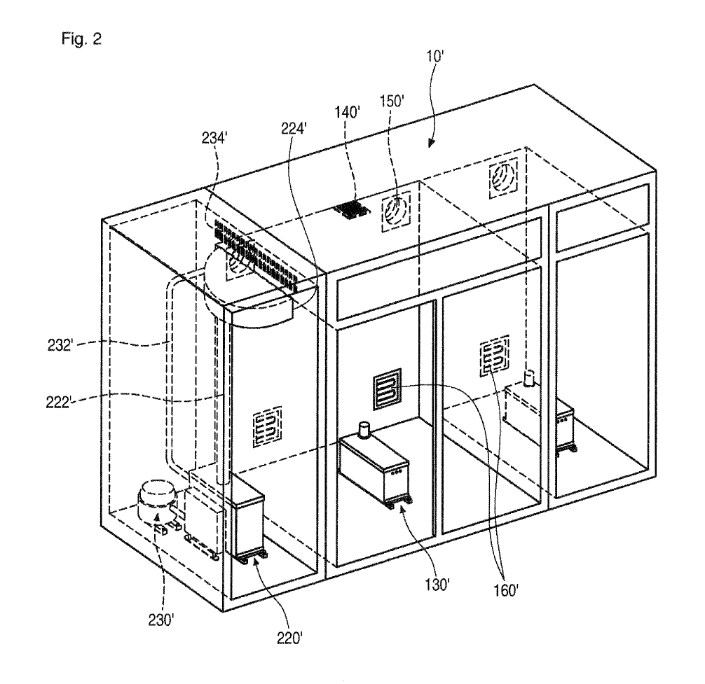

FIG. 2 is an inner perspective drawing of the inner structure of a black garlic aging device 10′ according to the example of the present invention.

In FIG. 2, in order to provide the heat, steam and chilly air according to each aging step into said aging chamber 100, a large-capacity steam generator 220 and a compressor 230 for generating chilly air are equipped in the control chamber 200 which is equipped at left of said black garlic aging device 10.

In detail, the steam which is generated through said large-capacity steam generator 220 is discharged into the steam opening which is formed at upper side of said aging chamber 100 via duct for steam which is funneled upward.

The above supplied steam is supplied into downward from upward of inner of said aging chamber 100′, the tray (not shown) at which the garlic for aging is stored, is heated and the steam is provided in the garlic which is stored in said tray.

In addition, in the final step of black garlic, the inner of said aging chamber 100 is maintained the condition of low temperature cooling for a long time in order to maintain the gummy tissue feeling of the aged black garlic, at this process, a compressor 230 for chilly air which is equipped in said control chamber 200 is opreatcd.

Chilly air generated from said compressor 230 is discharged into the aging chamber 100 via a chilly wind hole which is formed at upper side of said aging chamber 100 through duct for chilly air connected upward.

The aging chamber 100 is equipped at side of said control chamber 200.

Said aging chamber 100 comprises the tray guide 180 which guides the movement of forward-backward withdraw-incoming of inner of multiple trays (not shown) where said garlic is stored, and holds home-position, and the steam generator 130 which is equipped at inner bottom of said aging chamber 100 and generates steam in order to maintain reasonable inner humidity and temperature required for each aging stage.

Referring to the drawings, the hot air hole 150 is equipped at upper part of rear side of said aging chamber 100, and an electric heater 160 at the lower side.

Further, a ventilating shutter 140 is equipped at inner topside of said aging chamber 100.

The amount of steam generated, generation lasting time, on/off, etc. of said steam generator 130 are controlled at the following control part 210.

On the other hand, an electric heater 160 is equipped at the lower part of rear side of said aging chamber 100.

Said electric heater 160 is the heat source adapting the inner temperature of said aging chamber 100 to the temperature required for each aging stage, the control of their operation or not, calculated calorie, etc. is supervised by the following control part 210.

Next, at the upper part of rear side of said aging chamber 100, a hot air hole 150 is installed, into which the heat generated by the heating device (not shown) installed at outer side of said aging device 10 passing through the connected duct (not shown) is supplied.

With the hot wind flowed from the inner upper part of said aging chamber 100 through said hot air hole 150 and the double heat source supplied from the lower part of said aging chamber 100 by said electric heater 160, the temperature required for the garlic to be aged at each stage is controlled to be constant without inner temperature deviation of said aging chamber 100.

On the other hand, the ventilating shutter 140 is equipped at the inner upper side part of said aging chamber 100.

Said ventilating shutter 140 is the device forcing to emit the sulphur gas generated at the garlic aging process, and unnecessary humidity and heat source generated at each stage.

Said ventilating shutter 140 is connected to the outer upper side of said aging device 10, and has the structure that allows the up and down movement in accordance with operation or not.

Said ventilating shutter 140 is moved downward in the inner side of said aging chamber 100 in order riot to expose to the outer circumstance when forced ventilation is not needed, and is moved up and down in order to expose to the outer part of the upper side of said aging device 10 only when ventilation is needed.

Said ventilating shutter 140 is comprised of the gas emitting fan (not shown) forcing the ventilation and exhaust.

The operation or not and position of said ventilating shutter 140 is controlled by the following control part 210.

Furthermore, a steam generator 130 that generates steam to uniformly maintain the humidity inside said aging chamber 100 is equipped at the lower part inside said aging chamber 100′.

Said steam generator 130 is the device that supplies water in the form of steam into said aging chamber 100 in order to keep the humidity required at each step of the producing process of the black garlic.

Said steam generator 130 operates with the external power supply, its operation or not and operation time and the amount of steam generation are controlled by the control part 210 of said control chamber 200.

The steam supplied by the large capacity steam generator which is equipped inside said control chamber 200 is supplied through the steam hole in the upper side of said aging chamber 100.

However, the steam supplied through the steam hole in the upper side of said aging chamber 100 is not distributed uniformly inside said aging chamber 100.

Therefore, said steam generator equipped inside said aging chamber 100 makes said heterogeneous distribution of this steam uniform, and plays a role in the correction of the temperature departure as well as uniformity of the steam amount between up and down of said aging chamber 100.

On the other hand, the heat generated through the heating device (not shown) equipped at the rear of said aging chamber 100 is flowed into the inside of the chamber via the hot air hole connected by duct.

Further, in order to maintain the uniform temperature between up and down inside said aging chamber 100, the electric heater 160 is equipped lower inside the rear of the chamber to maintain the temperature required for each aging step.

The operation of said all steam, heat and chilly air generators can be automatically controlled in a wired or wireless way by the host (not shown) connected in a wired or wireless way, and have a structure to be controlled by operator's manual handling of said controller 210 equipped at said control chamber 200.

On the other hand, said door 120 is installed by a hinge joint in order to assemble into said aging device 10, and seals said aging chamber 100 by a door contract opening such as a loop.

On the other hand, at the upper part of said aging chamber 100, the ventilating shutter equipped to be connected to ventilating hole formed inside said aging chamber 100 is equipped.

Said ventilating shutter plays a role of emitting the heat, steam, sulphur gas, etc. generated inside said aging chamber 100. This open and close of said ventilating shutter can be operated manually, and the open and close by the motor, etc. can be automatically controlled by the wird or wireless signal of said host (not shown).

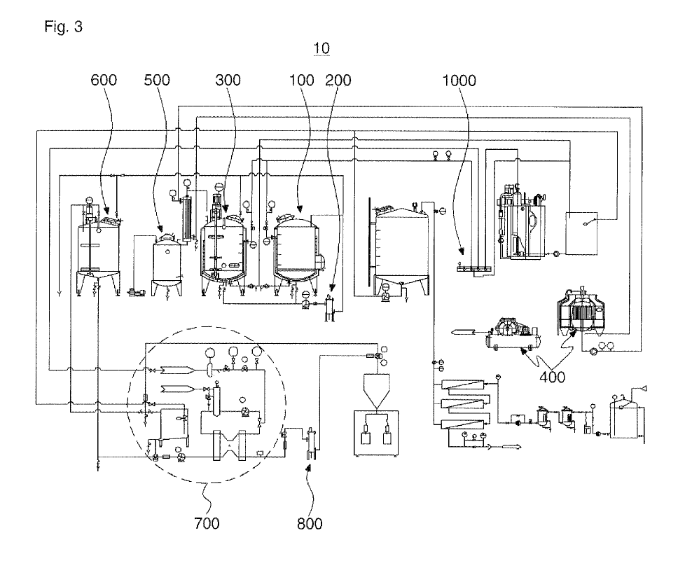

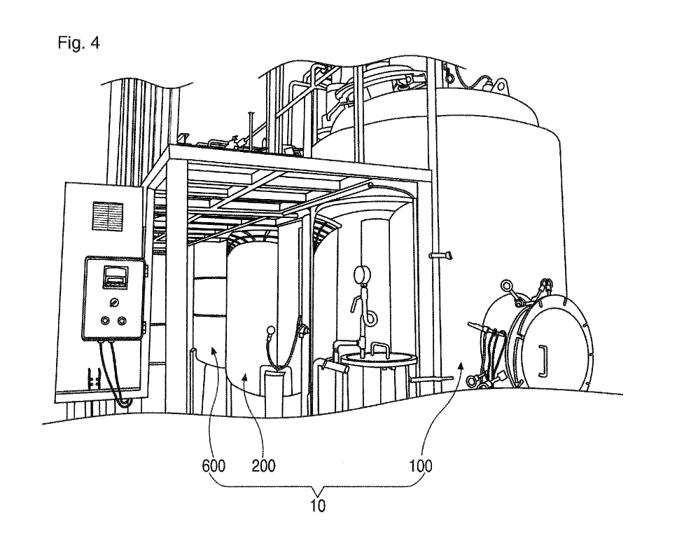

FIG. 3 is the drawing about total constitution of the aged black garlic concentrate producing device 10 by the example of the present invention. FIG. 4 is the perspective drawing of the extractor 100 and concentrator 300 of the aged black garlic concentrate producing device 10 by the example of the present invention.

In FIG. 3, the aged black garlic concentrate producing device 10 by the example of the present invention is constituted as follows.

In detail, said aged black garlic concentrate producing device 10 comprises a raw water storage tank (not shown) storing water supplied from the local water supply; a reverse osmosis filtering device (not shown) that removes turbidity and foreign substances, etc. included in the raw water stored at said raw water storage tank (not shown) via micro filter using the raw water supplying pump (not shown), and removes the minute foreign substance and ion components remaining in the raw water by the principle of the reverse osmosis by supplying to the semipermeable membrane by the high pressure pump; a purified water storage tank (not shown) produced by stainless steel that stores the purified water, i.e., the treated water passing through said reverse osmosis filtering device; an extractor 100 that extracts the black garlic concentrate via multistep control of extraction target temperature and time, after the stored purified water and the aged black garlic raw material are injected into said purified water storage tank (not shown); a raw material supplying circulating pump 200 that circulates the black garlic raw material in said extractor 100 upward and downward; a concentrator 300 that sets the final dry solid concentration from the black garlic concentrate extracted from said extractor 100; a primary filter 500 that filters the black garlic concentrate extracted from said extractor 100 via 20˜50 μm bag filtering filter before being transferred to said concentrator 300; a cooling tower 400 that collects the dry solid and the separated water outside by making inside said concentrator 300 a vacuum, refrigerates and stores in the condensate receiver tank; a mixing tank 600 that mixes the final products by mixing red ginseng concentrate and the concentrated black garlic concentrate in said concentrator 300; a sterilizer that performs a high short pasteurization of the products mixed in said mixing tank 600 at the ultrahigh temperature; a secondary filter 800 with a built-in 5 μm filter filtering the products passed through said sterilizer; and a filler 900 that individually packages the products passed through said secondary filter 800 in the certain amounts.

In more detail, said raw water storage tank (not shown) and said reverse osmosis filtering device (not shown) can be equipped in the space where said aged black garlic concentrate producing device 10 is installed, or separately.

Said raw water storage tank (not shown) is the tank that stores the water supplied from the local water supply for a while. Said raw water storage tank (not shown) is connected to said reverse osmosis filtering device (not shown), pipe, etc.

Said reverse osmosis filtering device (not shown) removes the foreign substances of the raw water transferred through the pipe by the raw water supply pump (not shown) via the micro filter.

Next, the raw water is supplied to the permeable membrane with high pressure by the high-pressure pump. Fine foreign substances and ion components remaining in the raw water supplied to the permeable membrane are removed by the principle of the reverse osmosis. Said reverse osmosis process performs the purification by passing through 5 μm filter as the primary filtering step. Then, the filtering process through 1 μm filter performs as secondary filtering step again.

After the above purification process, the purified water having the water quality of T.D.S 10 mg/L (at CaCO3) is produced. The purified water as above is stored in the purified water storage tank (not shown).

The above purified water storage tank (not shown) is made of stainless steel so that the purified water is not polluted, or is not damaged by the ultraviolet ray and sunlight, etc.

The above purified water is transferred into said extractor 100 in the necessary amount via the pipe by driving of the pump (not shown) from said purified water storage tank (not shown).

After the black garlic raw material aged in the pretreating step and the purified water transferred from said purified water storage tank (not shown) are injected into said extractor 100 at some rate, said black garlic raw material and purified water are mixed, and the concentrate is extracted from the aged black garlic raw material by maintaining at the extracting temperature of 85˜95° C. for about 18˜24 hrs.

During the extracting process from said extractor 100, said aged black garlic raw material is separated to the solids having some nutrient and water by applying some heat and pressure.

On the other hand, said extractor 100 is equipped with a raw material providing circulating pump 200. Said raw material providing circulating pump is the pump that circulates the black garlic and purified water in said extractor 100 upward and downward. The circulating action of said raw material providing circulating pump makes the extracting operation smooth and effective since the raw material in said extractor 100 is evenly heated.

The dry solid and water of said extracted black garlic is filtered through the primary filter 500.

Said primary filter 500 is equipped with 100 μm filter. Said filter is a bag type filter. The dry solid having big particles among the separated dry solid through said extractor 100 via said primary filtering is primarily filtered out.

The 100 μm or less of dry solid that filtered via said primary filter 500 and water are transferred to said concentrator 300. At this time, the primarily filtered black garlic concentrate is transferred to the concentrator 300 by the pump (not shown) via the supplying pipe (not shown).

Said concentrator 300 performs the process that the transferred black garlic concentrate is concentrated at a temperature of 55˜85° C. for 4˜12 hrs under a vacuum reduced pressure of 50˜76 cmHg. Through said concentration process, the dry solid having the active components and water are separated from said black garlic concentrate.

In said concentrator, the water separating operation is performed in the short time by operating the cooler for condensing the water evaporating from the raw material that are concentrated by applying the steam heating and vacuum pressure, and the vacuum pump for maintaining lower pressure than atmospheric pressure.

Said concentrator 300 is equipped with a stirring device that makes the concentrated raw material inside said concentrator uniformly heated. The one or more of said stirring device is equipped in said concentrator 300 upward and downward, and performs the stirring action of the raw material stored inside by rotating in the direction of left and right via the rotatory power of the motor.

Said stirrer preferably stirs by rotating in the speed of 30 to 45 rpm. The raw material, black garlic concentrate is uniformly heated by the stirring action by said stirrer, and the particles of raw material are uniformly grinded, so the concentration process is smoothly performed.

Through the above process, the operation of setting the concentration of the final dry solid of the black garlic concentrate is proceeded.

On the other hand, if the concentration process in said concentrator 300 is finished, the process of removing water from said concentrator 300 is performed.

Said concentration process is the process of concentrating said raw material by applying the high temperature of heat and pressure to the inside of said concentrator 300. At this time, water that is included in the raw material goes through the phase change into the high temperature steam.

Said concentrator 300 is connected to the cooling tower 400 via the pipe (not shown).

Said cooling tower 400 comprises the vacuum pump that makes the inside of said concentrator 300 vacuous, and the condensate receiver tank that receives outside the separated water from the dry solid by making the inside of said concentrator 300 vacuous and cools it down.

Next, the primary filtering process is performed via the primary filter 500.

Said primary filter 500 performs the filtering process through 25˜50 μm filter. Through above process, the process for producing the concentrate having fine density by filtering big particles from the concentrated black garlic concentrate through said concentrator 300.

The black garlic concentrate that primarily filtered as above is transferred to the mixing tank 600.

In said mixing tank 600, the black garlic concentrate that is primarily filtered is stirred via the stirrer one more time. The purpose of above process is to finally confirm the their quality before packaging the concentrated raw material liquid and to increase the taste of the black garlic concentrate.

Next, the black garlic concentrate goes through the pasteurization process by the short time high temperature pasteurizer 700.

Said short time high temperature pasteurizer 700 performs the pasteurization operation by transferring the water stored in the condensate receiver tank through the pipe in the form of high temperature of steam and water by heating with boiler.

Said short time high temperature pasteurizer 700 performs the high-temperature short-time pasteurization process pasteurizing at a temperature of 130˜135° C. for 1′-5 second(s).

The raw material being gone through said short-time high-temperature pasteurization process goes through the secondary filter 800.

Said secondary filter 800 is equipped with the 5 μm filter. If the black garlic concentrate is filtered via said secondary filter 800, the black garlic concentrate is produced to the final product having fine particles.

Said secondarily filtered black garlic concentrate is packaged to the individual product having some volume through the filler 900.

Said filler 900 performs the hot-filling process that the black garlic concentrate is packaged at 92˜96° C.

The individual procedure and constitution device as above have a control part 1000 that controls the each condition and time requiring for performing.

Said control part 1000 controls the operation or not and the operation time of each device and condition, the control of said control part 1000 can be performed manually by an operator in the each device and process, and can be performed automatically by program remotely through a wired or wireless network as necessary.

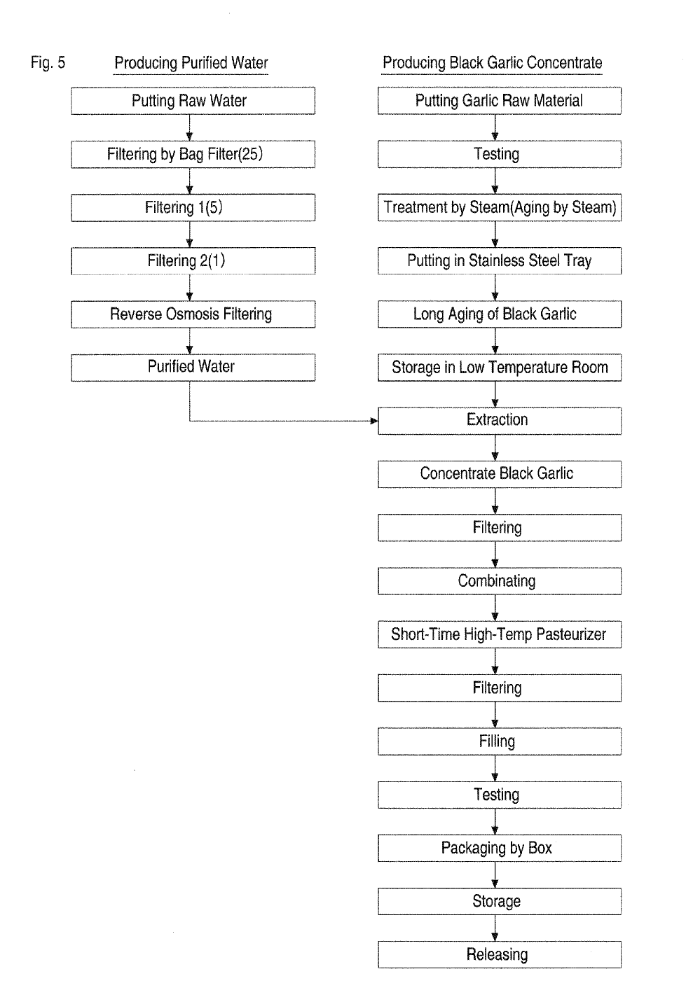

FIG. 5 is the flow chart showing the order about the method for producing the aged black garlic concentrate according to the example of the present invention.

Looking into, above all, after the grown garlic is classified by size, the appearance is cleaned by removing the each raw material root and core, then the pretreating stage storing the garlic at 15° C. or below of cool place in order not to spoil is performed.

After said stored garlic is sealed in a vinyl bag or polyethylene bag by 8˜10 kg, it is stored in each tray. Its purpose is to uniformly age the garlic to be going to age by the volume unit being set in a tray.

Next, the steam treating stage is performed. This stage is the procedure that the garlic is steam-aged by maintaining inside the aged black garlic aging device at a temperature of 85˜90° C. and a humidity of 100% RH for 30˜60 min. Through this procedure, the garlic loses the hard feeling by heat and steam, the spicy component of the raw garlic is released out.

Next, the main aging stage is performed. This stage is the stage that after said steam-treating stage, water of the garlic is preserved and the browning action is promoted by maintaining inside the aged black garlic aging device at a temperature of 70˜80° C. and a humidity of 60˜70% RH for 12˜15 days.

Next, the after-aging stage is performed. This stage is the stage maintaining inside the aged black garlic aging device at a temperature of 0˜5° C. and a humidity of 20˜30% RH for 7˜14 days.

This procedure is the stage that the spicy taste of the garlic is removed and the sweet and sour tastes are increased. After this stage, the black garlic has the chewy feeling and the high condition of sweet and sour tastes.

The black garlic produced as above loses the unique smell and spicy taste, and is changed to the best aged black garlic product that has sweet and sour tastes and chewy feeling; the handling and storability of the black garlic are easy as the surface is dry.

Next, the purified water for producing the aged black garlic concentrate with the aged black garlic is produced by entering the raw water to store, storing via the 25 μm bag filter, primarily filtering said raw water via 5 μm filter, secondarily filtering said primarily filtered water via 1 μm filter again, reverse osmosis filtering said secondarily filtered water through the osmosis filtering by removing foreign substances and ion components to produce the purified water.

Next, 1350 kg of said purified water and 450 kg of the aged black garlic are injected into the extractor to mix. Said extractor is maintained at a temperature of 85˜95° C. for 18˜24 hrs to extract the concentrate. The produced aged black garlic concentrate has a sugar content of 13 brix when measuring with a refractometer.

At this stage, said raw materials are stirred left and rightward at 30˜450 rpm via a stirring device, the stage is proceeded while maintaining the deviation of inner temperature by circulating upward and downward by the operation of the raw material providing circulating pump.

Then, the concentration stage is proceeded by concentrating the dry solid and water of said extracted black garlic by maintaining a vacuum reduced pressure of 60˜76 cmHg and a temperature of 55˜85° C. for 4˜12 hrs in concentrator. Said concentrated aged black garlic concentrate have a sugar content of 62 brix/20° C.

Said concentrated aged black garlic concentrate goes through the primarily filtering stage that the dry solid and water are separated via 25˜50 μm filter, the short-time pasteurization stage that it is pasteurized at a ultrahigh temperature of 130˜135° C. for 1˜5 sec(s) after said primarily filtering, and the secondarily filtering stage that the dry solid and water is separated via 5 μm filter after said short-time pasteurization stage.

Next, said secondarily filtered product goes through the filling stage that the product is individually packaged by 80 ml of filling amount at a temperature of 85˜95° C., and the stage prior to shipment that said filled product is tested, packaged with a box, and stored at a low temperature of 1˜4° C., to complete the final product.

By the method for producing the aged black garlic concentrate according to the example of the present invention, in the case of extracting the aged black garlic concentrate, the best product can be extracted by putting the optimal time, energy and raw material.

What is claimed is:

1. A method for producing an aged black garlic concentrate, comprising:
classifying the garlic by condition and pretreating for cleaning an appearance;
sealing the garlic in a polyethylene bag by 8˜10 Kg and storing in a tray;
putting said tray into an aging device for a black garlic, and steam-treating by applying steam and heat for 30˜60 min while maintaining inside the aging device at a temperature of 80˜90° C.;
main aging by aging the tray with said steam-treated garlic for 12˜15 days while maintaining inside the aging device at a temperature of 70˜80° C.;
after-aging by gradually removing the water from the tray with said main-aged garlic at a low temperature condition for 7˜14 days, while maintaining inside the aging device at a temperature of 0˜5° C.;
storing by putting raw water, and storing via a 25 μm bag filter;
obtaining primarily filtered water by purifying the raw water via a 5 μm filter;
obtaining secondarily filtered water by purifying again said primarily filtered-purified water via a 1 μm filter;
reverse osmosis filtering by removing foreign substances and ion components from said secondary filtered-purified water through the reverse osmosis step to yield purified water;
extracting the concentrate while maintaining at a temperature of 85˜95° C. for 18˜24 hrs by putting said reverse osmosis filtered-purified water and said after-aged black garlic into an extractor;
concentrating said garlic by maintaining the dry solid and water of said extracted black garlic in a thickener for 4˜12 hrs at a vacuum reduced-pressure of 60˜76 cmHg and a temperature of 55˜85° C.;
primarily filtering by separating the dry solid and water from said concentrated aged black garlic concentrate through 25˜50 μm filter;
short-time pasteurizing by pasteurizing them at an ultrahigh temperature of 130˜135° C. for 1˜5 second(s) after said primary filtering;
secondarily filtering by separating the dry solid and water through 5 μm filter, after said short-time pasteurizing;
filling them by individually wrapping said secondary filtered products with 80 ml or more at a temperature of 92˜96° C.;
and testing said filled products, packaging in a box, storing at a low temperature of 1˜4° C. before their shipment.

2. The method of claim 1, wherein said extracted aged black garlic concentrate has 13 brix/20° C. or more of the sugar content, and 13 weight % or more of the dry solid.

3. The method of claim 1, wherein the concentrated aged black garlic concentrate has 65 brix/20° C. or more of the sugar content.

4. The method of claim 1, wherein at said extracting step, said aged black garlic and purified water are mixed, and extracted while uniformly maintaining the inner temperature deviation by circulating up and down by the operation of the pump for supplying raw material, with stirring at a speed of 30˜45 rpm.

5. The method of claim 1, wherein the amount of purified water and after-aged garlic put into the extractor is at a ratio of 1350 kg water to 450 kg garlic.

6. The method of claim 5, wherein said extracted aged black garlic concentrate has 13 brix/20° C. or more of the sugar content, and 13 weight % or more of the dry solid.

7. The method of claim 5, wherein the concentrated aged black garlic concentrate has 65 brix/20° C. or more of the sugar content.

8. The method of claim 5, wherein at said extracting step, said aged black garlic and purified water are mixed, and extracted while uniformly maintaining the inner temperature deviation by circulating up and down by the operation of the pump for supplying raw material, with stirring at a speed of 30˜45 rpm.
